(19) United States
(12) Patent Application Publication
(10) Pub. No.: US 2021/0179473 A1
(43) Pub. Date: Jun. 17, 2021

(54) METHOD AND DEVICE FOR BENDING PANES

(71) Applicant: SAINT-GOBAIN GLASS FRANCE, COURBEVOIE (FR)

(72) Inventors: Arthur PALMANTIER, Aachen (DE); Jack PENNERS, Herzogenrath (DE); Achim ZEICHNER, Herzogenrath (DE); Werner KAHLEN, Herzogenrath (DE)

(21) Appl. No.: 16/635,087

(22) PCT Filed: Jun. 22, 2018
(86) PCT No.: PCT/EP2018/066747

§ 371 Date: Jan. 29, 2020

(30) Foreign Application Priority Data
Jul. 31, 2017 (EP) 17183930.1

(51) Int. Cl. C03B 23/03; C03B 23/035; C03B 35/20

(52) U.S. Cl. CPC C03B 23/0302; C03B 2225/02; C03B 35/202; C03B 23/0352

(57) ABSTRACT

A method for bending panes, includes providing a pane heated to bending temperature, securing the pane against a contact surface of a first bending mould, pressing the pane between the first bending mould and a press frame, transporting the pane on the press frame to a second bending mould, pressing the pane between the second bending mould and the press frame, securing the pane against the contact surface of the second bending mould, wherein surface pre-bending occurs in the inner region of the pane, transporting the pane on a tempering frame to a cooling device for the thermal tempering of the pane, wherein during transport, surface final bending occurs in the inner region of the pane by gravity.

The invention relates to a method and a device for bending panes and use thereof. Various bending methods, many of which have already found their way into the patent literature, are used in the industrial series production of glass panes.

For example, WO 2012/080072 describes a method with incremental bending of glass panes in the edge region and the inner region. Here, the glass pane is first moved on a pre-bending ring into a furnace, wherein the pane edge is pre-bent, followed by further bending of the pane edge by a first suction device, placement and bending of the glass pane in the surface on a final bending ring and finish bending to the desired final geometry by means of a second suction device. By means of the incremental bending of the glass panes, optical defects in complex plane shapes can be reduced.

In WO 2004/087590 and WO 2006072721, in each case, a method is described in which the glass pane is first pre-bent by gravity on a bending frame, followed by press bending using an upper or lower bending mould.

EP 255422 and U.S. Pat. No. 5,906,668 describe in each case the bending of a glass pane by suction against an upper bending mould.

Generally, there is a need for compact systems for bending glass panes, wherein the glass panes should be producible with relatively short cycle times and low production costs.

Consequently, the object of the present invention consists in making available an improved method compared to the previously known methods as well as a corresponding device for bending glass panes. These and other objects are accomplished according to the proposal of the invention by a device and a method for bending glass panes with the features of the coordinate claims. Advantageous embodiments of the invention are apparent from the dependent claims.

In the context of the present invention, the term “pre-bending” refers to an incomplete bending of the pane relative to a defined or definable final bending (final geometry or final shape) of the pane. The pre-bending can, for example, account for 10 to 80% of the final bending. When used as “edge pre-bending”, the term refers to the incomplete bending of the pane in a peripheral edge region of the pane adjacent a pane edge, typically an edge region surrounding the pane in a strip-like manner. For example, the strip width is in the range from 3 to 150 mm. The pane edge is formed by a (cut) surface that is typically arranged perpendicular to the two primary surfaces of the pane opposite one another. When used as “surface pre-bending”, the term refers to the incomplete bending of the pane in a central or inner region of the pane, which is surrounded by the edge region and is directly adjacent the edge region. In contrast, the term “final bending” refers to the complete bending of the pane. When used as “edge final bending”, the term refers to the complete bending in the edge region of the pane: when used as “surface final bending”, to the complete bending in the inner region of the pane.

The term “pane” refers generally to a glass pane, in particular a thermally tempered soda lime glass.

The term “laterally” or “laterally displaceable” refers to a movement with at least one horizontal moving component, as a result of which a structural component can be arranged laterally relative to another structural component.

The device for bending panes typically comprises multiple zones that are structurally and functionally distinguishable from one another. According to the invention, a thermal bending zone for bending heated panes, which is advantageously equipped with a heating device for heating the panes, is an essential element. In particular, the bending zone can, for this purpose, be brought to a temperature that enables plastic deformation of panes and is typically in the range from 600° C. to 750° C.

The bending zone comprises at least two bending moulds, in particular a first bending mould and a second bending mould. The first bending mould and the second bending mould have in each case a contact surface for contacting a pane. The contact surface of the first bending mould or the second bending mould has an outer surface section and an inner surface section or is composed of the outer and inner surface section. The outer surface section is suitably designed for edge final bending in an edge region of the pane. Preferably, the inner surface section of the first bending mould or the second bending mould is suitably designed for surface pre-bending in a central or inner region of the pane surrounded by the edge region. Alternatively, the inner surface section of the second bending mould can be suitably designed for surface final bending.

As used here and in the following, the phrase “suitably designed” in connection with the outer surface section of the contact surface means that the outer surface section is designed such that an edge final bending of the pane can be produced. However, the pane does not mandatorily have to be subjected to edge final bending, instead, it is possible for only edge pre-bending to be done. The edge final bending is, in that case, not produced until later in the process. The outer surface section does not, for this purpose, necessarily have to have a shape that is complementary to a pane that is finally bent at the edge. In connection with the inner surface section of the contact surface “suitably designed” means that the inner surface section is designed such that surface pre-bending of the pane can be produced, whereby surface pre-bending does not mandatorily have to be done. If the inner surface section of the second bending mould is, alternatively, suitably designed for surface final bending, this means that a surface final bending can be produced, but does not necessarily have to be produced. The surface final bending can then be produced later in the process.

Preferably, the first bending mould and the second bending mould have in each case a means for securing a pane against the respective contact surface.

The means for securing a pane against the contact surface advantageously comprises a pneumatic suction device for sucking a gaseous fluid, in particular air, by means of which the pane can be pulled by negative pressure against the respective contact surface. The contact surface can be provided, for this purpose, for example, with at least one suction hole, advantageously with a plurality of suction holes uniformly distributed, for example, over the contact surface, to which a negative pressure can be applied to the contact surface in each case for a suction effect. The suction device can, alternatively or additionally, have an apron surrounding the contact surface, by means of which a negative pressure can be produced on the contact surface. The suction device generates a typically upward directed flow of a gaseous fluid, in particular air, which suffices to firmly hold the pane against the contact surface. This enables, in particular, placing a frame for receiving the pane secured against the contact surface below the pane.

Alternatively or additionally, the means for securing a pane against the contact surface advantageously comprises a pneumatic blowing device for producing a gaseous flow of fluid, in particular a flow of air, which is designed such that a pane is blown on from below by the gaseous flow of fluid, raised thereby, and can be pressed against the contact surface of the first or second bending mould. The blowing device can, in particular, be designed such that the pane secured against the contact surface can be pre-bent in the edge region and/or in the inner region by the pressure exerted by the gaseous flow of air, advantageously at least in the edge region.

As used here and in the following, the term “securing” refers to a fixing of a pane against the contact surface, wherein the pane can be pressed against the contact surface and/or sucked against the contact surface. The securing of a pane against the contact surface is not mandatorily associated with a bending operation. The contact surfaces of the first and second bending mould are in each case oriented downward for contact with a pane.

The device for bending panes further comprises a press frame (e.g., a press ring) for transporting and pressing a pane. For this purpose, the press frame has a press surface (contact surface) for a pane, which is also designed complementary to an outer surface section of the first bending mould or the second bending mould suitable for edge final bending. The press surface is, for example, designed in the form of a strip, for example, with a strip width in the range from 3 to 150 mm. The press surface is oriented upward for contact with a pane. In addition, the press frame is suitably designed for pre-bending the surface by means of gravity in the inner region of the pane, wherein a sagging of the inner region of the pane downward by means of gravity is possible. The press frame can, for this purpose, be open, in other words, be provided with a central opening, or be full-surface, so long as sagging of the inner region of the pane is enabled. In terms of simpler processing of panes, an open design is preferred. It is understood that a greater width of a strip-shaped press surface is advantageous in terms of avoiding unwanted marks (changes in the flat surfaces of the pane), wherein by pressing the pane on the press frame in the edge region, the creation of marks can be counteracted. The press surface of the press frame has the defined geometry, wherein the press frame is sufficiently rigid for this purpose. The press frame is, for example, formed as a cast part, with the press surface formed, for example, by milling. In gravity bending, the pane is pre-bent by its own weight. As a result of the prior pressing of the pane edge against the press surface of the press frame, the surface pre-bending of the pane can be reduced. In addition, it is advantageously possible to use a stop for fixing the pane during transport on the press frame.

The first bending mould and the press frame are vertically displaceable relative to one another such that the pane can be pressed in the edge region between the outer surface section of the first bending mould and press surface of the press frame. The pane is thus pre-bent or finally bent in the edge region. The first bending mould is advantageously coupled with a movement mechanism by means of which the first bending mould can be delivered to the press frame. It is, however, also conceivable for the press frame to be delivered to the first bending mould.

Similarly, the second bending mould and the press frame are vertically displaceable relative to one another such that the pane can be pressed in the edge region between the outer surface section of the second bending mould and the press surface of the press frame. The pane is thus pre-bent or finally bent in the edge region. The second bending mould is advantageously coupled with a movement mechanism by means of which the second bending mould can be delivered to the press frame. Alternatively, it is possible for the press frame to be delivered to the second bending mould.

Advantageously, the press frame is laterally movable (in other words, with at least one horizontal moving component) reciprocally between a first press frame position associated with the first bending mould and a second press frame position associated with the second bending mould relative to the first and the second bending mould. Advantageously, the press frame is reciprocally and translationally (1-dimensionally) movable in the horizontal plane. Typically, the first press frame position is situated vertically (e.g., directly) below the first bending mould, and the second press frame position is situated vertically (e.g., directly) below the second bending mould.

Advantageously, the device according to the invention further has a preheating zone with a heating device for heating the panes to a bending temperature as well as a transport mechanism, in particular of the roller bed type, for transporting panes from the preheating zone to the bending zone, in particular to a removal position (e.g., directly) below the first bending mould. The roller bed is advantageously implemented such that individual panes can be transported one after another into the removal position. The removal position can, in particular, correspond to an end section of the roller bed.

Advantageously, the device according to the invention further has a thermal tempering zone with a cooling device for the thermal tempering of a pane, wherein a tempering frame (e.g., a tempering ring) is laterally movable reciprocally (in other words, with at least one horizontal moving component) for transporting a pane from a first tempering frame position associated with the second bending mould, which can, in particular, be identical to the second press frame position, to a second tempering frame position in the tempering zone relative to the second bending mould. Advantageously, the tempering frame is reciprocally and translationally (one-dimensionally) movable in the horizontal plane. By means of thermal prestressing (tempering) a temperature difference between a surface zone and a core zone of the pane is systematically produced in order to increase the breaking strength of the pane. The tempering of the pane is advantageously produced by means of a device for blowing on the pane with a gaseous fluid, preferably air. Preferably, the two surfaces of a pane are simultaneously subjected to a cooling flow of air.

With lateral displacement of the press frame and the tempering frame, a single-pane is transported in each case, enabling processing of two panes simultaneously on the two bending moulds, while a third pane is situated in the tempering zone. As a result of the preferably reciprocal translational movement of the press frame and/or the tempering frame, the individual panes can be transported efficiently and quickly between the various tools. Due to the bending of a pane in the edge region and the inner region carried out in multiple stages, the bending time on the second bending mould can be significantly reduced in order to shorten the cycle times. In addition, as a result, panes with complex geometry can also be made with high quality.

Advantageously, the tempering frame has, for transporting a pane from the bending zone to the tempering zone, a frame surface suitably designed for the edge final bending in the edge region of the pane (5). Moreover, it is advantageous for the tempering frame to be suitably designed for surface final bending by means of gravity in the inner region of the pane. If a pane that is placed on the tempering frame is first subjected to edge pre-bending and surface pre-bending, final edge bending and final surface bending can be achieved during transport on the tempering frame by means of gravity.

The device according to the invention for bending panes serves in particular for carrying out the method according to the invention described in the following. In this regard, reference is made to the statements above.

The method according to the invention includes a step in which a pane heated to bending temperature is provided.

The method includes another step in which the pane is secured against a contact surface of a first bending mould. Advantageously, a securing of the pane against the contact surface of the first bending mould is done in that the pane is raised by blowing on it with a gaseous fluid and pressing it against the contact surface of the first bending mould. Alternatively, and preferably additionally, the pane is secured against the contact surface of the first bending mould by suction. Depending on the pressure with which the pane is pressed against the contact surface of the first bending mould, the pane can be subjected to edge pre-bending in the edge region and/or surface pre-bending in the inner region.

The method includes another step in which the pane is pressed between the first bending mould and a press frame. The contact surface has an outer surface section suitably designed for edge final bending in an edge region of the pane. In addition, the press frame has a press surface that is complementary to the outer surface section of the first bending mould. Here, edge pre-bending or edge final bending in the edge region of the pane is done.

The method includes another step in which the pane is transported on the press frame to a second bending mould, wherein, during transport, pre-bending of the surface in the inner region of the pane surrounded by the edge region of the pane is done by gravity.

The method includes another step in which the pane is pressed between the second bending mould and the press frame, wherein the second bending mould has a contact surface with an outer surface section suitably designed for the edge final bending in the edge region of the pane, wherein the press surface of the press frame is complementary to the outer surface section of the second bending mould. Here, edge pre-bending or edge final bending in the edge region of the pane is done.

The method includes another step in which the pane is secured against a contact surface of the second bending mould. Advantageously, securing the pane against the contact surface of the second bending mould is done in that the pane is raised by blowing on with a gaseous fluid and is pressed against the contact surface of the second bending mould. Alternatively, and preferably additionally, the pane is secured against the contact surface of the second bending mould by suction. Depending on the pressure with which the pane is pressed against the contact surface of the second bending mould, the pane can be subjected to edge pre-bending in the edge region and/or surface pre-bending and/or surface final bending in the inner region. For example, the pane is secured by suction against the second bending mould, wherein the suction is so strong that the pane is subjected to surface final bending in the inner region and, possibly, to edge final bending in the edge region.

The method includes another step in which the pane is transported on a (cool) tempering frame to a cooling device for thermal tempering of the pane.

In an advantageous embodiment of the method according to the invention, edge pre-bending is done in the edge region of the pane by pressing the pane between the first bending mould and the press frame. Then, further edge pre-bending is done in the edge region of the pane by pressing the pane between the second bending mould and the press frame. Finally, edge final bending of the pane is done during transport of the pane on the tempering frame.

In another advantageous embodiment of the method according to the invention, edge pre-bending is done in the edge region of the pane by pressing the pane between the first bending mould and the press frame. Then, edge final bending is done in the edge region of the pane by pressing the pane between the second bending mould and the press frame.

In another advantageous embodiment of the method according to the invention, edge final bending is done in the edge region of the pane by pressing the pane between the first bending mould and the press frame.

In an advantageous embodiment of the method according to the invention, surface final bending in the inner region of the pane is done by gravity during transport on the tempering frame.

In another advantageous embodiment of the method according to the invention, the press frame is moved laterally relative to the first and the second bending mould between a first press frame position, which is associated with the first bending mould and is preferably situated (e.g., directly) below the first bending mould, and a second press frame position, which is associated with the second bending mould and is preferably situated (e.g., directly) below the second bending mould, in order to transport a pane from the first bending mould to the second bending mould. Preferably, the press frame is moved reciprocally (bidirectionally) translationally (one-dimensionally) in a horizontal plane between the first press frame position and the second press frame position.

Preferably, the pane is transported by a transport mechanism, in particular of the roller bed type, all the way to a removal position, which is associated with the first bending mould and is preferably situated (e.g., directly) below the first bending mould and, for example, (e.g., directly) below the first press frame position. The pane can then be secured against the contact surface of the first bending mould. Advantageously, while the pane is secured against the contact surface of the first bending mould, the press frame is transported to the first press frame position.

In an advantageous embodiment of the method according to the invention, while the pane is secured against the second bending mould, the tempering frame is transported to a first tempering frame position (typically below the second bending mould) associated with the second bending mould, the pane is placed on the tempering frame, and the tempering frame carrying the pane is moved laterally relative to the first and second bending mould to a second tempering frame position for the thermal tempering of the pane. Preferably, the tempering frame is moved reciprocally (bidirectionally) translationally (one dimensionally) in a horizontal plane between the first tempering frame position and the second tempering frame position.

The bending on the second bending mould can give the pane a final or quasi-final shape. Typically, but not mandatorily, the shape of the pane will still change (usually slightly) on the tempering frame, for which purpose the tempering frame preferably has a frame surface that is suitably designed for edge final bending. In addition, the tempering frame is suitably designed for surface final bending by gravitation. The pane thus receives its final shape on the tempering frame.

The invention further extends to the use of the device according to the invention as well as the method according to the invention for producing panes for means of transportation on land, in the air, or on water, in particular in motor vehicles, and in particular for rear windows in motor vehicles.

The various embodiments of the invention can be realised individually or in any combinations. In particular, the features mentioned above and to be explained in the following can be used not only in the combinations indicated, but also in other combinations or in isolation, without departing from the scope of the present invention.

The invention is explained in detail using exemplary embodiments and referring to the accompanying figures. They depict, in simplified, not-to-scale representation:

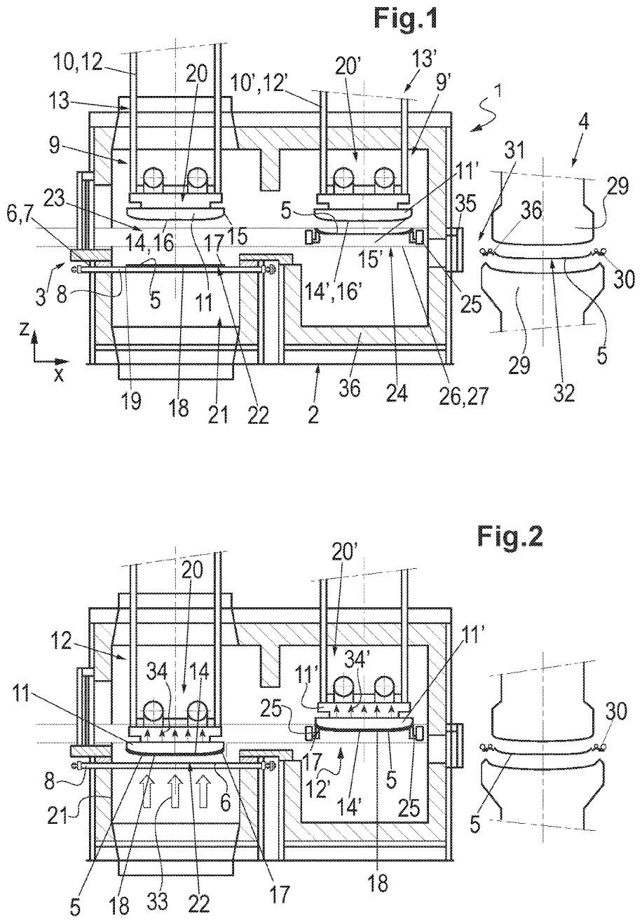

FIG. 1 a schematic representation of an exemplary embodiment of the device according to the invention for bending panes, in cross-section;

FIG. 2-7 the device according to the invention for bending panes of FIG. 1 at a later time in each case;

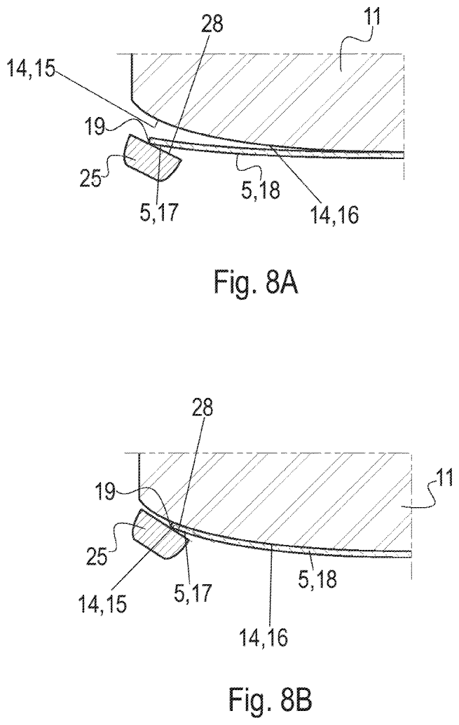

FIG. 8A-8B a schematic representation of the pressing of a pane between the first bending tool and the press frame;

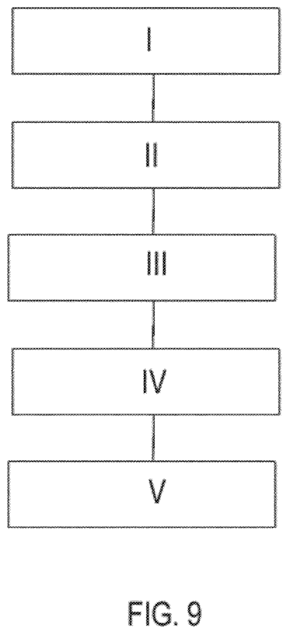

FIG. 9 a flowchart of the method according to the invention for producing a pane.

Consider first FIG. 1, which illustrates, using a schematic representation, an exemplary embodiment of the device according to the invention in a cross-sectional view. Referring to FIG. 1, essential components of the device for bending panes referenced as a whole with the reference number 1 are described. The device 1 comprises a bending zone 2 for bending (glass) panes 5, a preheating zone 3, arranged to the side of the bending zone 2, with a heating device for heating the panes 5 to bending temperature, which is not shown in detail in FIG. 1 since, in the view of the figures, it is situated behind the bending zone 2, and, arranged to the side, a tempering zone 4 for cooling or tempering bent panes 5. The tempering zone 4 is coupled on the right side to the bending zone 2. The preheating zone 3 and the tempering zone 4 are, viewed from above, arranged at an angle of 90° to the bending zone 2 and are functionally coupled thereto. Here, the preheating zone 3, the bending zone 2, and the tempering zone 4 are in each case spatially separate regions of the device. The bending zone 2 is implemented in the form of a bending chamber closed or closable to the external environment. The bending zone 2 is, for this purpose, provided with an insulating wall such that the interior of the bending zone can be heated to and kept at a temperature (bending temperature) suitable for the bending operation of the panes 5. For heating the interior, the bending zone 2 has a heating device, which is not shown in detail in FIG. 1.

In the device 1, the panes 5 can be transported successively from the preheating zone 3 into the bending zone 2 and, finally, into the tempering zone 4. Provided for transport of the panes 5 from the preheating zone 3 into the bending zone 2 is a pane transport mechanism 6, comprising, in the embodiment of FIG. 1, a roller bed 7 with cylindrical rollers 8 for flat support of panes 5. The rollers 8 are actively and/or passively rotatably mounted, with their horizontally oriented axes of rotation, here, for example, parallel to the x-direction. By means of the rollers 8, panes 5 heated in the preheating zone 3 to bending temperature are brought individually in each case one after another into a removal position 22 in the bending zone 2. The transport direction for the pane 5 is perpendicular to the plane of the drawing.

The bending zone 2 has two separate bending stations 9, 9′, with a first bending station 9 and a second bending station 9′ arranged physically offset from one another in the horizontal x-direction. In the description of the two bending stations 9, 9′, the reference characters with “′” refer in each case to a component of the second bending station 9′, with components of the second bending station also possibly not having “′”, when this seems appropriate. For easier reference, all components of the second bending station 9′ are also referred to as “second” components, in contrast to the components of the first bending station 9, which are also referred to as “first” components.

The bending stations 9, 9′ have in each case a vertical holder 10, 10′ for releasable attachment of a bending tool 11, 11′. The holders 10, 10′ are in each case vertically displaceable by a holder moving mechanism 13, 13′ (not depicted in detail). Optionally, the holders 10, 10′ are laterally displaceable by the moving mechanism 13, 13′ in each case also with at least one horizontal movement component, in particular in the positive or negative x-direction. The bending tool 11, 11′ is in each case detachably mounted at the lower end of the holders 10, 10′. Each bending tool 11, 11′ has a downward-directed, convex contact surface 14, 14′ for the flat contact of a pane 5. With appropriate contact pressure, the pane 5 can be bent on the respective contact surface 14, 14′. The two contact surfaces 14, 14′ have, for this purpose, in each case an end or edge outer surface section 15, 15′ and an inner surface section 16, 16′ with mutually different surface contours (surface shapes), wherein the inner surface section 16, 16′ is completely surrounded (bordered) by the outer surface section 15, 15′.

In addition to the mutually different surface contours of an outer surface section 15, 15′ and an inner surface section 16, 16′ of one and the same bending tools 11, 11′, the contact surfaces 14, 14′ of the two bending tools 11, 11′ also have different surface contours. Specifically, the outer surface section 15 of the contact surface 14 of the first bending tool 11 has a surface contour that corresponds to a desired edge final bending, i.e., final bending, in a (for example, strip-shaped) edge region 17 of the pane 5, in other words, enables such final bending. The end edge region 17 of the pane 5 is adjacent a pane (cut) edge 19 arranged perpendicular to the two opposing pane primary surfaces.

The inner surface section 16 of the contact surface 14 of the first bending tool 11 has a surface contour that corresponds to a surface pre-bending, i.e., non-final bending, in an inner region 18 of the pane 5 completely surrounded by the edge region 17. The outer surface section 15′ of the contact surface 14′ of the second bending tool 11′ has a same surface contour as the outer surface section 15 of the contact surface 14 of the first bending tool 11 and has a surface contour that corresponds to the desired edge final bending in the edge region 17 of the pane 5. In contrast to the inner surface section 16 of the contact surface 14 of the first bending tool 11, the inner surface section 16′ of the contact surface 14′ of the second bending tool 11′ has a surface contour that corresponds to a surface final bending, i.e., a final or quasi-final bending, in the inner region 18 of the pane 5. The first holder 10 forms, together with the first bending tool 11, a first bending mould 12. In a corresponding manner, the second holder 10′ forms, together with the second bending tool 11′, a second bending mould 12′.

The two bending stations 9, 9′ are in each case provided with a suction device 20, 20′ for sucking a pane 5 against the contact surface 14, 14′. For this purpose, the contact surfaces 14, 14′ can, for example, be provided with evenly distributed suction holes (not shown) and/or an apron positioned at the edge. By means of a negative pressure or a vacuum that is produced, a pane 5 can be pulled against the contact surface 14, 14′.

The first bending station 9 further has a blowing device 21 (not shown in detail) by means of which a flowing gaseous fluid, for example, an air flow 33 can be produced in a vertical direction through the roller bed 7 at the removal position 22. As a result, a pane 5 can be raised from the removal position 22 in the direction of the bending mould 12. The removal position 22 is situated in a vertical direction directly below the bending tool 11 of the first bending mould 12.

The bending station 9 further has a press frame 25 (e.g., a press ring) for pressing and transporting a pane 5. The press frame 25 is fixedly mounted on an elongated carrier 27 and can be laterally displaced by moving the carrier 27 in a positive and negative x-direction relative to the first and second bending mould 12, 12′. The carrier 27 can be moved by a carrier movement mechanism 26 (not shown in detail) along its extension direction. Thus, the press frame 25 can be moved back and forth translationally in particular between a first press frame position 23 of the first bending station 9 and a second press frame position 24 of the second bending station 9′. The first press frame position 23 and the second press frame position 24 are situated here, for example, in the same horizontal plane. The removal position 22 is situated directly below the first press frame position 23.

The press frame 25 has an edge-positioned (for example, strip-shaped) press surface 28 (see FIGS. 8A and 8B), whose surface contour is complementary to the surface contour of the outer surface section 14 of the bending tool 11 of the first bending mould 12. The upward facing press surface 28 is suitable for pressing a pane 5 resting thereon in the edge region 17. The press frame 25 is not implemented full surface, but, instead, has an inner opening, which enables gravity pre-bending of the surface of the inner region 18 of a pane 5 placed thereon.

The tempering zone 4 laterally coupled to the bending zone 2 has two so-called “tempering boxes” 29, which are arranged offset from one another in the vertical direction. By means of the two tempering boxes 29, a flow of air can be generated in each case for air cooling a pane 5 situated between the two tempering boxes 29 in order to temper the bent pane 5. Situated in the tempering zone 4 is a tempering frame 30 for transport and support during tempering of a bent pane 5. The tempering frame 30 can be displaced laterally by a tempering frame movement mechanism 31 (not shown in detail here) along at least one horizontal movement component relative to the bending station 2. Specifically, the tempering frame 30 can be moved back and forth translationally in a horizontal plane between a second tempering frame position 32, which is situated between the two tempering boxes 29 of the tempering station 4, and a first tempering frame position 24, which is identical to the second press frame position. For this purpose, the bending zone 2 implemented as a bending chamber has a door 35. In this manner, the tempering frame 30 can be driven into the second bending zone 24, to pick up a fully bent pane 5 and to transport it into the tempering zone 4. From there, the pane 5 can be removed in a simple manner and further processed.

Reference is now made to FIG. 1 to 7, wherein the device 1 for bending panes 5 of FIG. 1 is depicted in each case at different successive times during a bending process in order to describe an exemplary method for bending panes 5. For better clarity, only selected components of the device 1 are provided with reference numbers.

FIG. 1 depicts a situation during the bending process wherein a pane 5 has been brought into the removal position 22 of the first bending station 9. The first bending mould 12 is situated in a raised position above the pane 5. The second bending mould 12′ is situated at approx. the same height as the first bending mould 12. Below the second bending mould 12′, the press frame 25 is situated in the second press frame position 24 of the second bending station 9′ with a further pane 5 placed thereon. The tempering frame 30 is situated in the second tempering frame position 32 of the tempering zone 4 between the two tempering boxes 29.

FIG. 2 depicts the device 1 for bending panes 5 at a later time than FIG. 1. The first bending mould 12 has been driven downward in the direction of the pane 5 from the raised position into a first lowered position. The pane 5 has been raised by blowing on with the blowing device air flow 33 (symbolically represented by arrows) generated by the blowing device 21 on its lower side in the vertical direction from the removal position 22 in the direction toward the first bending mould 12 and is pressed by the blowing device air flow 33 against the contact surface 14 of the first bending tool 11. In the first lowered position of the first bending mould 12, the contact surface 14 is lowered far enough for the pane 5 to be able to be pressed by the blowing device air flow 33 against the contact surface 14. In addition, the pane 5 is secured against the contact surface 14 by suction by means of the suction device 20. The suction device air flow 34 producing a negative pressure on the contact surface 14 is also symbolically represented by arrows. As a result of the typically incomplete contact against the contact surface 14, a pre-bending of the pane 5 occurs only in the edge region 17. Generally, the pressing pressure from the blowing device air flow 33 is not sufficient to produce a edge final bending in the edge region 17 of the pane 5. On the other hand, the sucking action of the suction device 20 serves substantially only for holding the pane 5 against the contact surface 14, until the press frame 25 has traveled under the pane 5, and has only a slight influence on the bending of the pane 5. Nevertheless, bubbles in the pane 5 can be removed thereby. In the inner region 18 of the pane 5, only pre-bending of the surface is still possible as result of the contact surface 14. FIG. 2 depicts a situation in which the pane 5 is already secured against the contact surface 14.

The second bending mould 12′ has been brought from the raised position into a lowered position in which there is surface contact between the contact surface 14′ and the pane 5 positioned on the press frame 25. Here, the pane 5 is pressed in the edge region 17 between the outer surface section 15′ of the contact surface 14′ of the bending tool 11′ and the press surface 28 of the press frame 25 (see FIGS. 8A and 8B). The press surface 28 as a shape complementary to the outer surface section 15′ of the contact surface 14. As a result, the edge region 17 of the pane 5 is preferably fully bent, in other words, receives its edge final bending. It is, however, also possible for the edge region 17 to only be pre-bent. Subsequently, the pane 5 is secured against the contact surface 14′ by suction by means of the suction device 20′. It is conceivable for the contact surface 14′ to, alternatively, have a small distance from the pane 5, if suction of the pane 5 over a certain distance is possible. The suction device air flow 34′ generating negative pressure on the contact surface 14′ is symbolically represented by arrows. In contrast to the first bending mould 12 where only holding of the pane 5 is intended and the negative pressure thus causes no bending (at least no notable bending) of the pane 5, the suction of the pane 5 against the contact surface 14′ can also serve for bending the pane 5, in other words, sufficient mechanical pressure to bend the pane 5 as desired is generated by the suction. Thus, the pane 5 is pre-bent on the second contact surface 14′ in the inner region 18 of the pane 5. In addition, a previously produced edge final bending in the edge region 17 can be maintained on the pane 5. The tempering frame 30 is still situated in the tempering device 4 between the two tempering boxes 29.

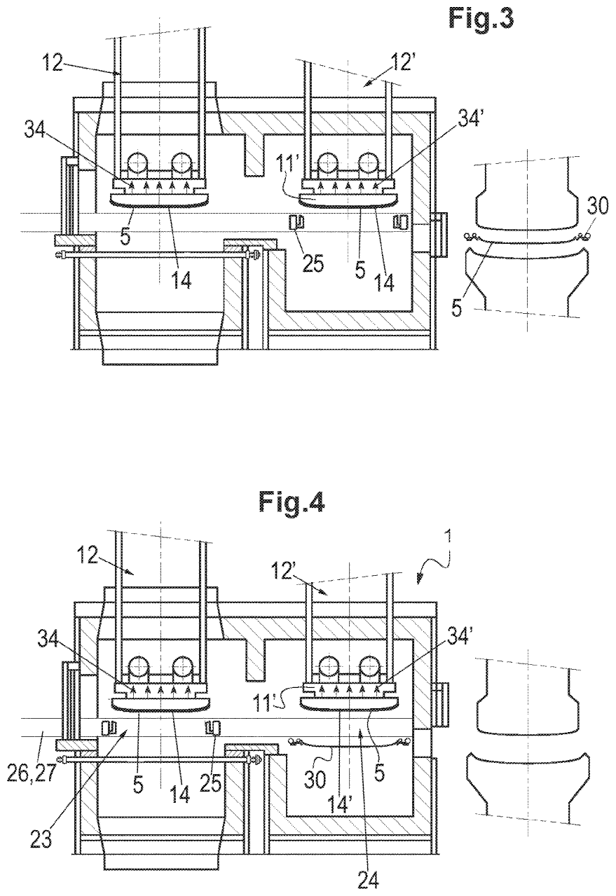

FIG. 3 depicts the device 1 for bending panes 5 at a later time than FIG. 2. The first bending mould 12 has again been moved upward into its raised position, wherein the pane 5 is secured against the contact surface 14 by the suction device air flow 34. The second bending mould 12′ has also been moved upward into its raised position, wherein the pane 5 is secured against the contact surface 14′ by the suction device air flow 34′. The press frame 25 is pane-free and is situated below the second bending mould 12′. The tempering frame 30 is still situated in the tempering device 4 between the two tempering boxes 29.

FIG. 4 depicts the device 1 for bending panes 5 at a later time than FIG. 3. The first bending mould 12 is depicted in a situation wherein it has moved downward on the way into a second lowered position above the first lowered position. The pane 5 is still secured against the contact surface 14 by the suction device air flow 34. The press frame 25 has been moved translationally by means of the carrier movement mechanism 26 on the carrier 27 in a horizontal direction (negative x-direction) from the second press frame position 24 to the first press frame position 23 and is situated below the first bending mould 12. The second bending mould 12′ is still situated in its raised position, wherein the pane is secured against the contact surface 14′ by the suction device air flow 34′. The tempering frame 30 has been moved from the tempering position 32 into the second press frame position 24 of the second bending station 9′ and is situated below the second bending mould 12′.

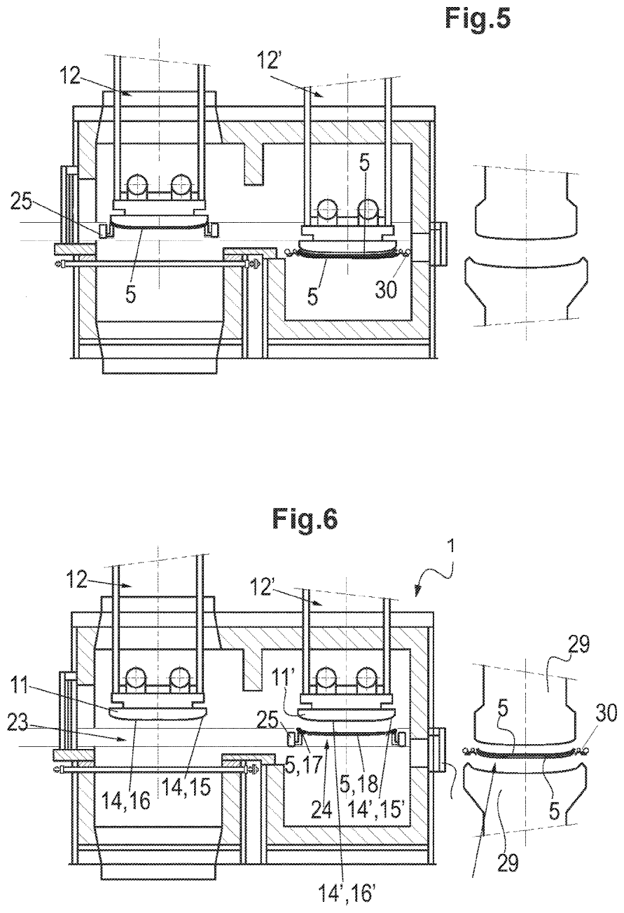

FIG. 5 depicts the device 1 for bending panes 5 at a later time than FIG. 4. The first bending mould 12 has now been moved into the second lowered position, wherein the pane 5 comes into contact with the press frame 25. Here, the pane 5 is pressed in the edge region 17 between the outer surface section 15 of the contact surface 14 of the bending tool 11 and the press surface 28 of the press frame 25 (see FIGS. 8A and 8B). The press surface 28 has a shape complementary to the outer surface section 15 of the contact surface 14. The edge region 17 of the pane 5 is, thereby, pre-bent or fully bent. A major advantage of the pressing of the pane 5 against the press frame 25 is a resultant very precise definition of the position of the pane 5 on the press frame 5 with precise contact of the edge region 17 of the pane 5 on the press surface 28 of the press frame 25. This enables precise positional fixation of the pane 5 on the press frame 25 by means of the stop (not shown in detail) resting against the pane 5. Thus, particularly high production accuracy and good optical quality of the bent pane can be achieved. The second bending mould 12′ has been moved into its lowered position, wherein the pane 5 is placed on the tempering frame 30.

FIG. 6 depicts the device 1 for bending panes 5 at a later time than FIG. 5. The first bending mould 12 and second bending mould 12′ have, in each case, been moved back into their raised position. The press frame 25 has been moved translationally in a horizontal direction (positive x-direction) from the first press frame position 23 to the second press frame position 24 and is situated below the second bending mould 12′. In particular, during transport, the pane 5 situated on the press frame 25 is pre-bent in the inner region 18 by gravity. As a result of the pressing in the edge region 17, the surface pre-bending by means of gravity is limited in the inner region 18. The tempering frame 30 with the pane 5 placed thereupon has been moved from the second press frame position 24 of the second bending station 9′ into the tempering position 32 and is situated between the two tempering boxes 29. To enable exit from the bending zone 2, the door 35 was opened for a short time. Thus, an appreciable temperature loss in the bending zone 2 can be prevented. During transport on the tempering frame 30, an edge final bending of the edges and a surface final bending of the pane 5 can be done by gravity. The tempering frame 30 has, for this purpose, an upwardly directed frame surface 36 for contact with the pane 5, which is suitably designed for an edge final bending. In addition, the tempering frame 30 is suitably designed for a surface final bending by gravitation.

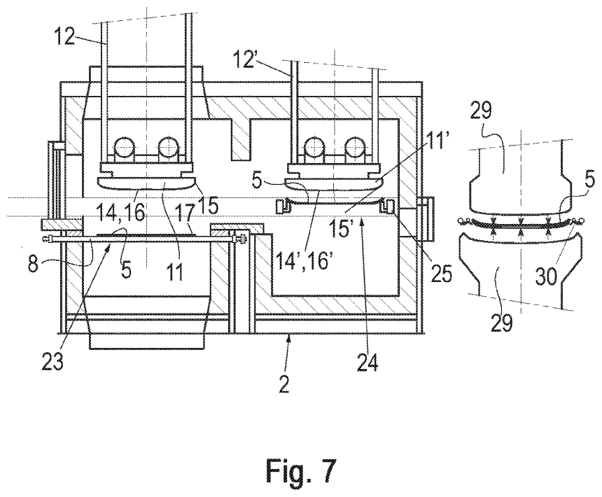

FIG. 7 depicts the device 1 for bending panes 5 at a later time than FIG. 6. The first bending mould 12 and second bending mould 12′ are still situated in the raised position. A new pane 5 has been brought into the removal position 22 of the first bending station 9. The pane 5 situated on the press frame 25 can be pressed and suctioned by the second bending mould 12′. The pane 5 situated in the tempering zone 32 is cooled by an air flow for tempering, as illustrated by arrows. The situation of FIG. 7 thus resembles the situation of FIG. 1. In this manner, the bending process can be carried out continuously.

Although this is not shown in FIG. 1 to 7, it would be equally possible for the press frame 25 to remain fixed in position (stationary) in each case within the bending station 2 and for only the first bending mould 12 and second bending mould 12′ to be laterally displaced in each case relative to the stationary press frame 25.

FIGS. 8A and 8B depict the pressing of the pane 5 between the press frame 25 and the contact surface 14 of the first bending tool 11. Discernibly, the contact surface 14 has an outer surface section 15 and an inner surface section 16 with different surface contours. The outer surface section 15 has a surface contour that corresponds to the desired edge final bending in the edge region 17 of the pane 5 or enables such bending. The inner surface section 16 has a surface contour that corresponds to a surface pre-bending in the inner region 18 of the pane 5 or enables such pre-bending. The press surface 28 of the press frame 25 has a surface contour that is complementary to the surface contour of the outer surface section 15 of the contact surface 14. FIG. 8A depicts a situation in which the inner region 18 of the pane 5 comes to rest against the inner surface section 16 (first contact). This can already be construed as pressing. In FIG. 8B, the pane 5 has, even in the edge region 17, made complete contact against the outer surface section 15 of the contact surface 14, with the desired edge final bending in the edge region 17 having been produced.

FIG. 9 illustrates, referring to a flowchart, the successive steps of the method for producing the pane 5. Therein, in a first step I, a pane 5 heated to bending temperature is provided. In a second step II, the pane 5 is secured against the contact surface 14 of the first bending mould 12, wherein the contact surface has an outer surface section 15 that corresponds to an edge final bending in edge region 17 of the pane 5 and an inner surface section 16 that corresponds to a surface pre-bending in the inner region of the pane 5, wherein optionally edge pre-bending is done in the edge region 17 and optionally pre-bending of the surface is done in the inner region 18 of the pane 5. In a third step II, the pane 5 is pressed in the edge region 17 against the press surface 28 of the press frame 25, wherein the press surface 28 is complementary to the outer surface section 15 of the contact surface 14, wherein a (further) edge pre-bending or an edge final bending is done in the edge region 17 of the glass pane 5. In a fourth step IV, the pane 5 is transported on the press frame 25 to the second bending mould 12′, wherein, in particular, during transport a (further) surface pre-bending in the inner region 18 of the pane 5 is done by means of gravity. In a fifth step V, the pane 5 is pressed against the contact surface 14′ of the second bending mould 12′ and then secured against the contact surface 14′, wherein (if not already done) edge pre-bending or edge final bending is done in the edge region 17 and surface pre-bending or final bending of the surface is done in the inner region 18 of the pane 5.

In an exemplary embodiment of the method according to the invention, edge pre-bending in the edge region of the pane 5 is done by means of pressing the pane 5 between the first bending mould 12 and the press frame 25, and edge pre-bending in the edge region 17 of the pane 5 is done by means of pressing the pane 5 between the second bending mould 12′ and the press frame 25, wherein an edge final bending of the edges is done during transport on the tempering frame 30. During transport on the press frame 25, surface pre-bending is done in the inner region of the pane 5 by gravity. During transport on the tempering frame 30, surface final bending is done in the inner region of the pane 5 by gravity. The pane thus receives its final shape only on the tempering frame.

In another exemplary embodiment of the method according to the invention, edge pre-bending in the edge region 17 of the pane 5 is done by pressing the pane 5 between the first bending mould 12 and the press frame 25, and an edge final bending in the edge region 17 of the pane 5 is done by means of pressing the pane 5 between the second bending mould 12′ and the press frame 25. During transport on the tempering frame 30, a further edge final bending is done only in the sense that the already present edge final bending is not lost, i.e., the edge final bending is maintained. During transport on the press frame 25, surface pre-bending in the inner region of the pane 5 is done by gravity. During transport on the tempering frame 30, surface final bending in the inner region of the pane 5 is done by gravity. The pane 5 thus receives its final shape in the edge region 17 already by means of the second bending mould 12′. The pane 5 receives its final shape in the inner region only on the tempering frame 30.

In another exemplary embodiment of the method according to the invention, an edge final bending in the edge region 17 of the pane 5 is done by pressing the pane 5 between the first bending mould 12 and the press frame 25. During transport on the press frame 25 and tempering frame 30, a further edge final bending is done only in the sense that the already present edge final bending is not lost, i.e., the edge final bending is maintained. During transport on the press frame 25, surface pre-bending in the inner region of the pane 5 is done by gravity. During transport on the tempering frame 30, a surface final bending in the inner region of the pane 5 is done by gravity. The pane 5 thus receives its final shape in the edge region 17 already by means of the first bending mould 12. The pane 5 receives its final shape in the inner region only on the tempering frame 30.

In all embodiments of the method, edge pre-bending and/or surface pre-bending can be done by securing the pane 5 against the first bending mould 12 or the second bending mould 12′. In addition, a surface final bending can be done by securing the pane 5 against the second bending mould 12′.

From the above, it is clear that the invention provides a method as well as a compact device for producing panes by means of which a simple and economical production of panes with short cycle times is enabled. In particular, the throughput with complex glass designs can be increased. Particularly advantageously, the transport time on the press frame between the two bending moulds can be used for gravity bending in the inner region of the surface. By pressing a pane between a first bending mould and a press frame in the edge region of the pane, wherein the pane is pre-bent or final bent in the edge region, a precise definition of position of the pane can be achieved such that the pane can be produced with high quality requirements.

### LIST OF REFERENCE CHARACTERS

1 device
2 bending zone
3 preheating zone
4 tempering zone
5 pane
6 pane transport mechanism
7 roller bed
8 roller
9,9′ bending station
10,10′ holder
11,11′ bending tool
12,12′ bending mould
13,13′ holder movement mechanism
14,14′ contact surface
15,15′ outer surface section
16,16′ inner surface section
17 edge region
18 inner region
19 pane edge
20,20′ suction device
21 blowing device
22 removal position
23 first press frame position
24 second press frame position, first tempering frame position
25 press frame
26 carrier movement mechanism
27 carrier
28 press surface
29 tempering box
30 tempering frame
31 tempering frame movement mechanism
32 second tempering frame position
33 blowing device air flow
34,34′ suction device air flow
35 door
36 frame surface

1. A method for bending panes, comprising:
providing a pane heated to bending temperature,
securing the pane against a contact surface of a first bending mould,
pressing the pane between the first bending mould and a press frame, wherein the contact surface has an outer surface section that is suitable for an edge final bending in an edge region of the pane, wherein the press frame has a press surface that is complementary to the outer surface section of the first bending mould,
transporting the pane on the press frame to a second bending mould, wherein surface pre-bending occurs in an inner region of the pane surrounded by the edge region by means of gravity during transport,
pressing the pane between the second bending mould and the press frame, wherein the second bending mould has a contact surface with an outer surface section that is suitable for the edge final bending in the edge region of the pane, wherein the press surface of the press frame is complementary to the outer surface section of the second bending mould,
securing the pane against the contact surface of the second bending mould
transporting the pane on a tempering frame to a cooling device for the thermal tempering of the pane.

2. The method according to claim 1, wherein
by means of pressing the pane between the first bending mould and the press frame, edge pre-bending occurs in the edge region of the pane,
by means of pressing the pane between the second bending mould and the press frame, edge pre-bending occurs in the edge region of the pane,
edge final bending occurs during transport on the tempering frame.

3. The method according to claim 1, wherein
by means of pressing the pane between the first bending mould and the press frame, edge pre-bending occurs in the edge region of the pane,
by means of pressing the pane between the second bending mould and the press frame, edge final bending occurs in the edge region of the pane.

4. The method according to claim 1, wherein by means of pressing the pane between the first bending mould and the press frame, edge final bending occurs in the edge region of the pane.

5. The method according to claim 1, wherein during transport on the tempering frame, surface final bending of the surface occurs in the inner region of the pane by means of gravity.

6. The method according to claim 1, wherein the pane is secured against the contact surface of the first bending mould and against the contact surface of the second bending mould by
blowing on the pane with a gaseous fluid, as a result of which the pane is raised and is pressed against the contact surface of the bending mould, and/or
sucking the pane against the contact surface.

7. The method according to claim 1, wherein the press frame is moved laterally between a first press frame position associated with the first bending mould and a second press frame position associated with second bending mould relative to the first and the second bending mould to transport a pane from the first bending mould to the second bending mould.

8. The method according to claim 7, wherein, while the pane is secured against the contact surface of the first bending mould, the press frame is transported to the first press frame position.

9. The method according to claim 1, wherein, while the pane is secured against the contact surface of the second bending mould, the tempering frame for supporting the pane is transported to a first tempering frame position associated with the second bending mould, the pane is placed on the tempering frame, and the tempering frame carrying the pane is moved laterally relative to the second bending mould to a second tempering frame position for tempering the pane.

10. A device for bending panes for carrying out the method according to claim 1, comprising:
a bending zone with a first bending mould and a second bending mould, wherein the first bending mould has a contact surface with an outer surface section suitable for an edge final bending in an edge region of a pane, and the second bending mould has a contact surface with an outer surface section suitable for the edge final bending in the edge region of a pane,
a press frame for transporting a pane that has a press surface that is in each case complementary to the outer surface section of the first bending mould and to the outer surface section of the second bending mould, wherein the press frame is suitable for surface pre-bending in the inner region of a pane by means of gravity, wherein
the first bending mould and the press frame are vertically movable relative to one another, and the second bending mould and the press frame are vertically movable relative to one another such that a pane can be pressed between the outer surface section of the first bending mould and the press surface of the press frame as well as between the outer surface section of the second bending mould and the press surface of the press frame.

11. The device according to claim 10, further comprising a tempering frame for transporting a pane from the bending zone to a tempering zone with a cooling device for the thermal tempering of a pane, wherein the tempering frame has a frame surface suitable for the edge final bending in the edge region of the pane and is suitably designed for surface pre-bending in the inner region of a pane by gravity.

12. The device according to claim 11, wherein the tempering frame is laterally movable relative to the second bending mould from a first tempering frame position associated with the second bending mould to a second tempering frame position in the tempering zone.

13. The device according to claim 10, wherein the contact surface of the first bending mould and the contact surface of the second bending mould have in each case an inner surface section for surface pre-bending or surface final bending in the inner region of a pane.

14. The device according to claim 10, further comprising
a suction device for securing a pane against the contact surface of the first bending mould and/or a blowing device for raising and pressing a pane against the contact surface of the first bending mould, and/or
a suction device for securing a pane against the contact surface of the second bending mould and/or a blowing device for raising and pressing a pane against the contact surface of the second bending mould.

15. The device according to claim 10, wherein the press frame is laterally movable relative to the first and second bending mould between a first press frame position associated with the first bending mould and a second press frame position associated with the second bending mould.
